(19) United States
(12) Patent Application Publication
(10) Pub. No.: US 2016/0041093 A1
(43) Pub. Date: Feb. 11, 2016

(54) METAMATERIAL AND BIOLOGICAL AND CHEMICAL DETECTING SYSTEM

(71) Applicant: National Tsing Hua University, Hsinchu City (TW)

(72) Inventors: Ta-Jen YEN, Hsinchu City (TW); Cheng-Kuang CHEN, Hsinchu City (TW); Chu-En LIN, Hsinchu City (TW); Hui-Wen CHENG, Hsinchu City (TW)

(21) Appl. No.: 14/601,948

(22) Filed: Jan. 21, 2015

(30) Foreign Application Priority Data
Aug. 8, 2014 (TW) 103127275

(51) Int. Cl. G01N 21/552; G01N 21/41; G01N 21/359; G02B 1/00

(52) U.S. Cl. CPC G01N 21/554; G02B 1/002; G01N 21/41; G01N 21/359; G01N 2021/3595

(57) ABSTRACT

A metamaterial is suitable for receiving a detecting wave. The detecting wave interacts with the metamaterial. The metamaterial includes a substrate and at least one unit cell placed on the substrate. The size of the unit cell is at least less than ⅓ of the wavelength of the detecting wave. A biological and chemical detecting system using the metamaterial is also disclosed.

### CROSS REFERENCE TO RELATED APPLICATIONS

This Non-provisional application claims priority under 35 U.S.C. §119(a) on Patent Application No(s). 103127275 filed in Taiwan, Republic of China on Aug. 8, 2014, the entire contents of which are hereby incorporated by reference.

### BACKGROUND OF THE INVENTION

1. Field of Invention

The present invention relates to a metamaterial and a biological and chemical detecting system. Particularly, the present invention relates to a metamaterial and a biological and chemical detecting system that do not need labeling and coupling processes.

2. Related Art

Recently, various kinds of biological and chemical detecting and imaging system have been developed, and the application fields thereof become wider and wider. In this biological and chemical detecting technology, the most important applications include the biological microscopy technology and functional group signal enhancing technology. The related biological microscopy technology includes, for example, confocal microscopy, STED (stimulated emission depletion) microscopy, or other biological microscopies.

However, all of the above-mentioned biological microscopy technologies need a fluorescent labeling step during the imaging procedure. The fluorescent labeling may cause the damage of living cells and, more seriously, affect the Physiological functions of the living cells.

Therefore, it is desired to provide a metamaterial and a biological and chemical detecting and imaging system that do not need the labeling and coupling steps for minimizing the damage of the analyte during detection.

### SUMMARY OF THE INVENTION

In view of the foregoing description, an objective of the present invention is to provide a metamaterial and a biological and chemical detecting system that do not need the labeling and coupling steps for minimizing the damage of the analyte during detection.

To achieve the above objective, the present invention discloses a metamaterial including a substrate and at least one unit cell placed on the substrate. The metamaterial is suitable for receiving a detecting wave, and the detecting wave interacts with the metamaterial. The size of the unit cell is less than ⅓ of the wavelength of the detecting wave.

In one embodiment, the size is a distance between two most outer ends of the unit cell along a predetermined direction.

In one embodiment, the metamaterial further includes a plurality of unit cells arranged as an array.

In one embodiment, the unit cell is made of a dielectric material, a conductive material or their combination.

In one embodiment, the metamaterial has a negative refractive index.

To achieve the above objective, the present invention further discloses a biological and chemical detecting system suitable for detecting an analyte. The system includes a detecting wave generator and a metamaterial. The detecting wave generator provides a detecting wave. The metamaterial includes a substrate and at least one unit cell placed on the substrate. A size of the unit cell is less than ⅓ of the wavelength of the detecting wave. The detecting wave enters the metamaterial so as to generate a reacting wave, and the reacting wave interacts with the analyte to generate a detecting signal.

In one embodiment, the size is a distance between two most outer ends of the unit cell along a predetermined direction.

In one embodiment, the metamaterial further includes a plurality of unit cells arranged as an array.

In one embodiment, the unit cell is made of a dielectric material, a conductive material or their combination.

In one embodiment, the detecting signal represents the refractive index and the resonance frequency of the analyte.

In one embodiment, the metamaterial has a negative refractive index.

In one embodiment, the detecting wave is an electromagnetic wave.

As mentioned above, the biological and chemical detecting system of the invention utilizes the metamaterial to perform biological detection. The metamaterial includes a substrate and at least one unit cell, and the size of the unit cell is less than ⅓ of the wavelength of the detecting wave. The detecting wave enters the metamaterial so as to generate a reacting wave, and the reacting wave interacts with the analyte to generate a detecting signal. The detecting signal can represent a refractive index and a resonance frequency of the analyte.

The biological and chemical detecting system of the invention can visualize the surface of the analyte (e.g. the cell) without using the labeling and coupling steps in the biological and chemical detection procedure. This can decrease the damage of the analyte during the detection procedure and observe the components of the internal of the analyte according to the functional group signal.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram showing a metamaterial according to a preferred embodiment of the invention;

FIG. 2 is a schematic diagram showing a unit cell of the metamaterial of FIG.

1;

FIGS. 3A to 3F are schematic diagrams showing various aspects of the unit cell of FIG. 2;

FIG. 4 is a schematic diagram showing a biological and chemical detecting system according to a preferred embodiment of the invention;

FIG. 5 is a schematic diagram showing another biological and chemical detecting system according to the preferred embodiment of the invention;

FIG. 6 is a schematic diagram showing the detecting signal spectrum (the functional group signal) according to the preferred embodiment of the invention;

FIG. 7A is a schematic diagram showing an image obtained by a reflective-index optical microscopy;

FIG. 7B is a schematic diagram showing an image obtained by a confocal fluorescent microscopy; and

FIG. 7C is a schematic diagram showing a measurement result of a detecting signal (the refractive-index signal) according to the preferred embodiment of the invention.

### DETAILED DESCRIPTION OF THE INVENTION

The present invention will be apparent from the following detailed description, which proceeds with reference to the accompanying drawings, wherein the same references relate to the same elements. To be noted, the drawings of the invention are only for illustrations and not to represent the real sizes and scales.

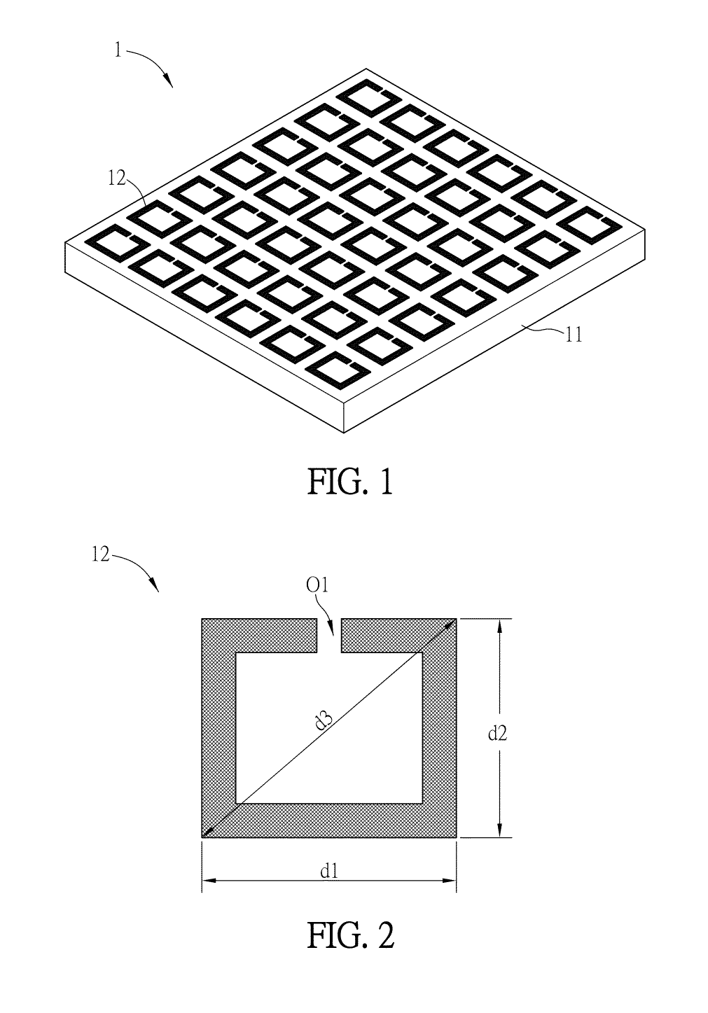

FIG. 1 is a schematic diagram showing a metamaterial according to a preferred embodiment of the invention. Referring to FIG. 1, the metamaterial 1 of the embodiment includes a substrate 11 and at least one unit cell 12 disposed on the substrate 11. For example, the unit cell 12 can be formed on the substrate 11 by E-beam lithographic, nanoimpring and lift-off process. The substrate 11 can be, for example but not limited to, a silicon substrate, a SiO₂ substrate, or a BaF₂ substrate, or a CaF substrate. The unit cell 12 can be made of a dielectric material, a conductive material or their combination. In this embodiment, the metamaterial 1 can have a negative refractive index, but this invention is not limited.

The unit cell 12 is a patterned structure. In particular, the unit cell 12 is a split ring structure (SRS), or a structure having an extension with resonance effect. The “split ring structure” is an annular structure with at least one cutting or a structure having at least one segment and a cutting. In some aspects, the split ring structure is designed as a fourfold symmetric structure, which will be discussed hereinafter. In addition, since the conductive material can provide a better resonance effect, the unit cell 12 is preferably made of a conductive material such as metal, semimetal, semiconductor, superconductor, silicide, carbide, or any material with conductivity. For example, gold (Au) is a preferred material for manufacturing the unit cell 12. Since gold has the properties of high stability and low oxidation rate, the unit cell 12 made of gold can have lower interaction rate with other substances or environment.

In this embodiment, the substrate 11 has a plurality of unit cells 12 arranged in an array as shown in FIG. 1. The gap between two unit cells 12 is, for example, 1 μm. In practice, when the gap between the unit cells 12 is smaller (which means the density of the unit cells 12 is higher), the resonance intensity caused by the local electric field is stronger. This invention does not limit the number of the configured unit cells 12 and the gap size between the unit cells 12, and these factors can be adjusted based on the actual needs.

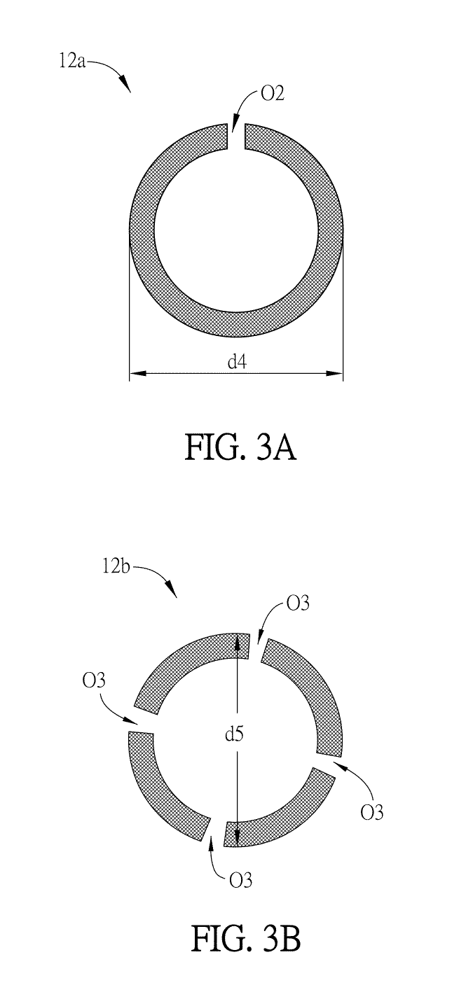

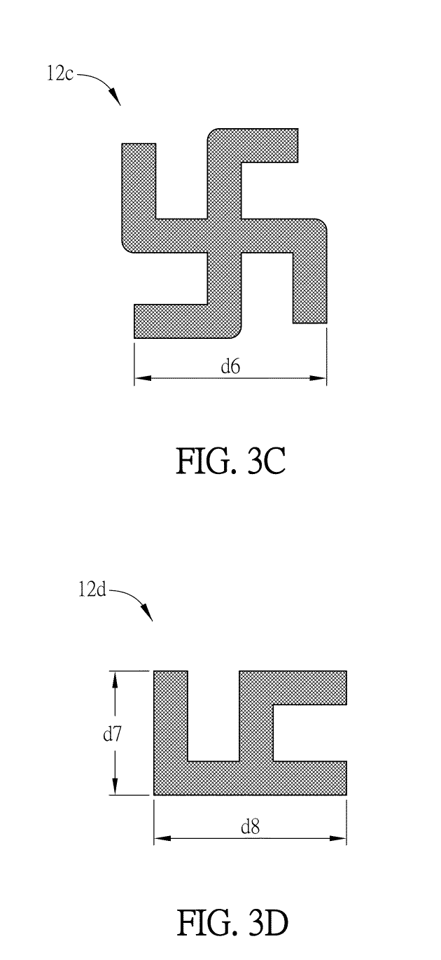

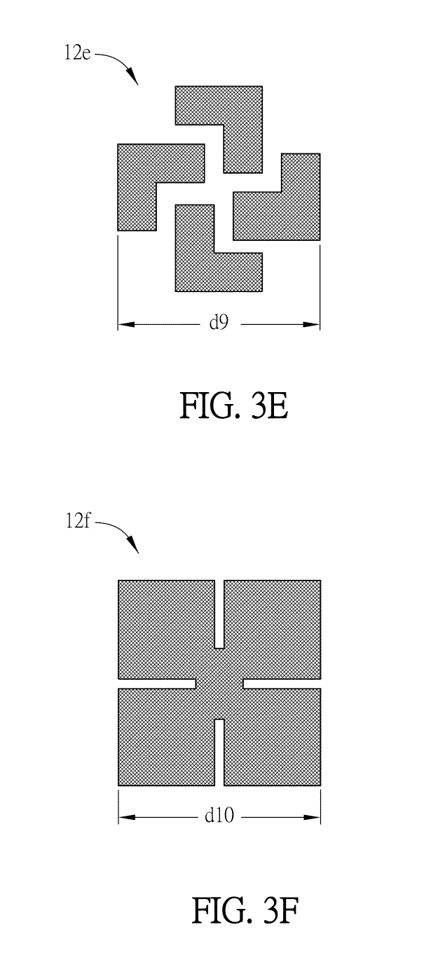

FIG. 2 is a schematic diagram showing a unit cell 12 of the metamaterial 1 of FIG. 1. Referring to FIG. 2, the unit cell 12 is a square structure with a cutting O1, and the material of the unit cell 12 is gold. To be noted, the shape of the unit cell 12 is not limited to FIG. 2, and it can have various aspects such as the shapes shown in FIGS. 3A to 3F. In practice, the shape, size or other parameters of the unit cell 12 can affect the resonance waveband thereof. Although the above description shows some aspects of the shape of the unit cell 12, those skilled persons should know that the different shapes of the unit cell 12 do not affect the spirit of this invention.

In this embodiment, the size of the unit cell 12 is at least less than ⅓ of the wavelength of the detecting wave. The size of the unit cell 12 is a distance between two most outer ends of the unit cell 12 along a predetermined direction. The predetermined direction can be any direction. As shown in FIG. 2, the size of the unit cell 12 can be the distance d1 or d2 between two sides of the unit cell 12 or the distance d3 of the diagonal of the unit cell 12. As shown in FIG. 3A, the unit cell 12a is a circular structure with a cutting O2, and the size thereof is the diameter d4 of the unit cell 12a. As shown in FIG. 3B, the unit cell 12b is a circular structure with a plurality of cuttings O3, and the size thereof is the diameter d5 of the unit cell 12b. As shown in FIG. 3C, the unit cell 12c is a gammadion shaped structure, for example, H-shaped structure, and the size thereof is the distance d6. As shown in FIG. 3D, the size of the unit cell 12d is the distance d7 or d8. As shown in FIG. 3E, the size of the unit cell 12e is the distance d9. As shown in FIG. 3F, the size of the unit cell 12f is the distance d10. The unit cells 12c, 12e and 12f of FIGS. 3C, 3E and 3F are the above-mentioned fourfold symmetric structure.

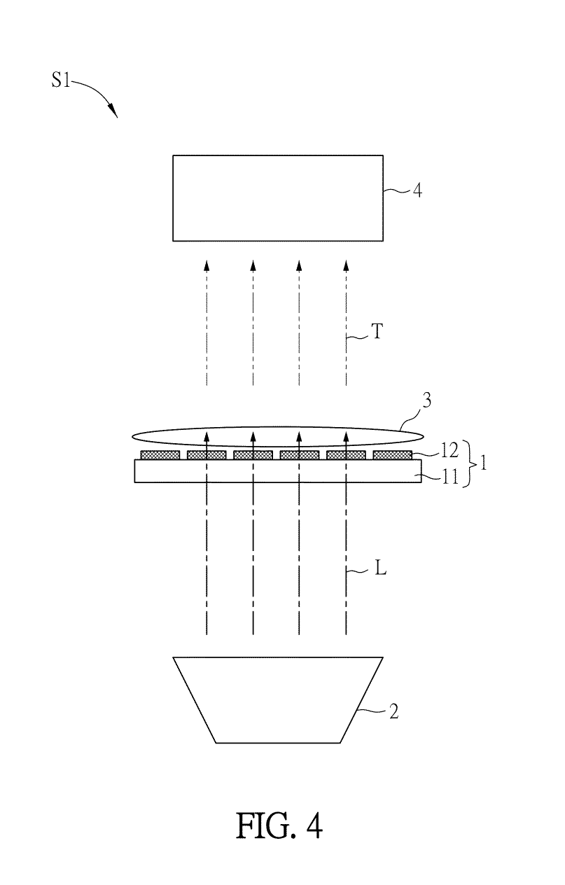

FIG. 4 is a schematic diagram showing a biological and chemical detecting system S1 according to a preferred embodiment of the invention. Referring to FIG. 4, the biological and chemical detecting system S1 of the embodiment includes a metamaterial 1 and a detecting wave generator 2. The detecting wave generator 2 provides a detecting wave L. The detecting wave L is an electromagnetic wave, which can be visible light or invisible light. In this embodiment, the detecting wave L is an infrared light, which has a spectrum within the near-infrared region (750 nm˜1400 nm). The size of the unit cell 12 of the metamaterial 1 is less than ⅓ of the wavelength of the detecting wave L. The detailed description thereof can be referred to the above embodiment, so it will be omitted hereinafter. The detecting wave generator 2 is disposed at one side of the substrate 11 away from the unit cell 12, and the analyte 3 is disposed at one side of the metamaterial 1 configured with the unit cell 12 (see FIG. 4). In practice, the analyte 3 can be a cell, tissue, crystal, polymer, bio organics, or the likes.

In this embodiment, after the detecting wave L is emitted from the detecting wave generator 2 and then entered into the metamaterial 1, it can induce local electric field to cause resonance at the surface of the metamaterial 1 so as to generate a reacting wave. The reacting wave is caused by the localized surface plasmon resonance (LSPR). Afterwards, the reacting wave interacts with the analyte 3 to generate a detecting signal. In more detailed, the electromagnetic wave will focus on the surface of the metamaterial 1, and the analyte 3 interacts with the enhanced electromagnetic wave. That is, the analyte 3 will absorb the electromagnetic wave and thus generate the detecting signal. The detecting signal can represent the refractive index and resonance frequency of the analyte 3. In practice, the biological and chemical detecting system S1 may further include a receiving element 4 such as, for example but not limited to, a CCD (charge coupled device) system or FPA (focal planar array) in cooperated with a Fourier transform infrared spectrum system (FTIR) for receiving the detecting signal. Since the receiving element 4 and the detecting wave generator 2 are disposed at different sides of the metamaterial 1, this structure is suitable for measuring a transmission wave T.

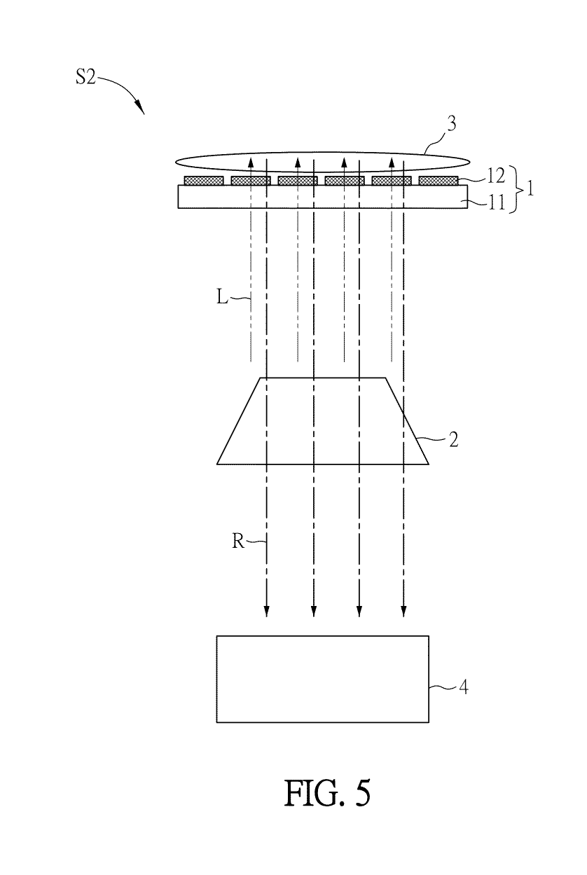

FIG. 5 is a schematic diagram showing another biological and chemical detecting system S2 according to the preferred embodiment of the invention. Different from the system S1 of FIG. 4, the receiving element 4 and the detecting wave generator 2 of the system S2 of FIG. 5 are located at the same side of the metamaterial 1. After entering the analyte 3, the detecting wave L can be split into a transmission wave T (as shown in FIG. 4) and a reflective wave R. This structure of FIG. 5 is suitable for detecting the reflective wave R.

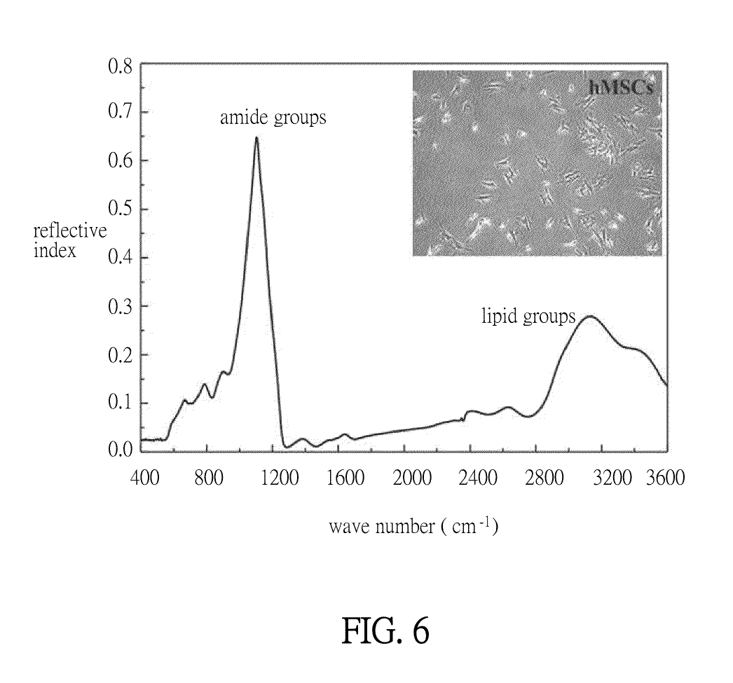

FIG. 6 is a schematic diagram showing the detecting signal (the functional group signal) according to the preferred embodiment of the invention. The detecting signal is obtained by using the biological and chemical detecting system S2 of FIG. 5 to detect hMSCs (human bone marrow-derived mesenchymal stem cells). In other words, the hMSCs are the analyte 3 of FIG. 5, and the microscopic photo shown in the up-right corner of FIG. 6 indicates the hMSCs. Referring to FIGS. 5 and 6, after the detecting wave L enters the metamaterial 1, the local electric field can cause the localized surface plasmon resonance of the metamaterial 1, thereby generating a reacting wave. Then, the reacting wave interacts with the analyte 3 to generate a detecting signal. In this case, the detecting signal received by the receiving element 4 is the functional group signal of FIG. 6, which represents the resonance frequency of the functional group of the analyte 3. FIG. 6 shows a reflective spectrum for example. In more detailed, the signals of the molecules in hMSCs are majorly ranged within 600˜1800 (cm⁻¹) (amide groups) and 2800˜3200 (cm⁻¹) (lipid groups). In general, the intensity of the biological signal or chemical component signal of hMSCs is relatively weaker. However, it is needed to obtain an enhanced functional group signal to perform the analysis in biological and chemical detection. In the present embodiment, the enhanced functional group signal can be provided by the resonance of the metamaterial 1 caused by the local electric field. This enhanced functional group signal can not only facilitate to identify the biological and chemical components in the analyte, but also provide a more reliable signal.

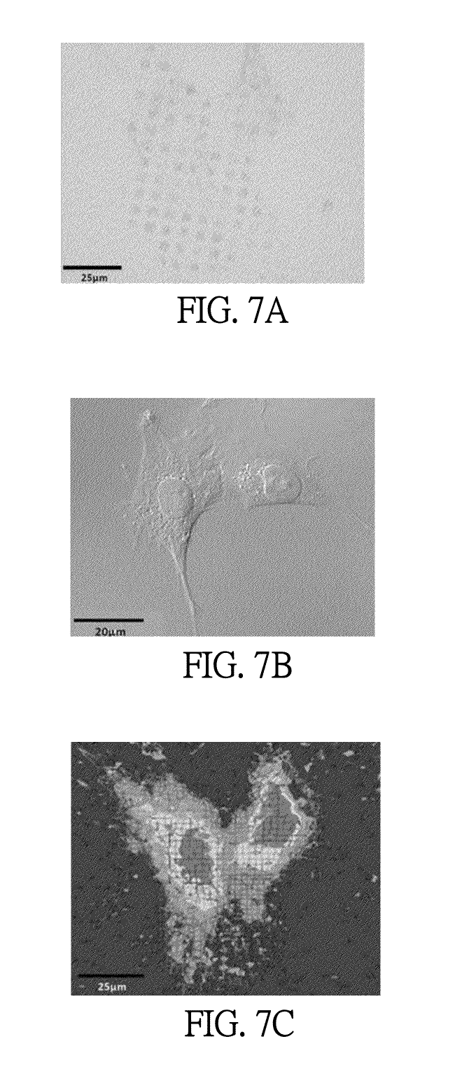

FIG. 7A is a schematic diagram showing an image obtained by a reflective optical microscopy, FIG. 7B is a schematic diagram showing an image obtained by a confocal fluorescent microscopy, and FIG. 7C is a schematic diagram showing a measurement result of a detecting signal (the refractive index signal) according to the preferred embodiment of the invention. Referring to FIGS. 7A to 7C in view of FIG. 4, the detecting signal received by the receiving element 4 can be a signal representing the refractive index of the analyte 3. For example, when the analyte 3 is a cell, the system S1 utilizes the receiving element 4 to receive the transmission waves of different positions so as to generate an image signal corresponding to the organelles of the cell (see FIG. 7C).

Compared to FIG. 7A (the image obtained by a reflective optical microscopy) and FIG. 7B (the image obtained by a confocal fluorescent microscopy), the image signal shown in FIG. 7C is more sensitive to the variation of refractive index, so it is benefit for the operator to observe the organelles inside the cell. Since the biological and chemical detecting systems S1 and S2 can detect the analyte without using the conventional fluorescent labeling and coupling steps, they can avoid the damage of the cell caused by the labeling procedure.

In summary, the biological and chemical detecting system of the invention utilizes the metamaterial to perform biological detection. The metamaterial includes a substrate and at least one unit cell, and the size of the unit cell is less than ⅓ of the wavelength of the detecting wave. The detecting wave enters the metamaterial so as to generate a reacting wave, and the reacting wave interacts with the analyte to generate a detecting signal. The detecting signal can represent a refractive index and a resonance frequency of the analyte.

The biological and chemical detecting system of the invention can visualize the surface of the analyte (e.g. the cell) without using the labeling and coupling steps in the biological and chemical detection procedure. This can decrease the damage of the analyte during the detection procedure and observe the components of the internal of the analyte according to the functional group signal.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A metamaterial suitable for receiving a detecting wave, wherein the detecting wave interacts with the metamaterial, the metamaterial comprising:
a substrate; and
at least a unit cell placed on the substrate, wherein a size of the unit cell is at least less than ⅓ of the wavelength of the detecting wave.

2. The metamaterial of claim 1, wherein the size is a distance between two most outer ends of the unit cell along a predetermined direction.

3. The metamaterial of claim 1, further comprising:
a plurality of unit cells arranged as an array.

4. The metamaterial of claim 1, wherein the unit cell is made of a dielectric material, a conductive material or their combination.

5. The metamaterial of claim 1, wherein the metamaterial has a negative refractive index.

6. A biological and chemical detecting system suitable for detecting an analyte, the system comprising:
a detecting wave generator for providing a detecting wave; and
a metamaterial, comprising;
a substrate, and
at least a unit cell disposed on the substrate, wherein a size of the unit cell is less than ⅓ of the wavelength of the detecting wave;
wherein, the detecting wave enters the metamaterial so as to generate a reacting wave, and the reacting wave interacts with the analyte to generate a detecting signal.

7. The system of claim 6, wherein the size of the unit cell is a distance between two most outer ends of the unit cell along a predetermined direction.

8. The system of claim 6, wherein the metamaterial further comprises a plurality of unit cells arranged as an array.

9. The system of claim 6, wherein the unit cell is made of a dielectric material, a conductive material or their combination.

10. The system of claim 6, wherein the detecting signal represents a refractive index and a resonance frequency of the analyte.

11. The system of claim 6, wherein the metamaterial has a negative refractive index.

12. The system of claim 6, wherein the detecting wave is an electromagnetic wave.
